(19) United States
(12) Patent Application Publication
(10) Pub. No.: US 2004/0242232 A1
(43) Pub. Date: Dec. 2, 2004

(54) Successful termination to a visiting wireless mobile terminal using MIN escape code in IS41

(76) Inventors: Mark A. McCormick, Naperville, IL (US); Vladimir P. Sliva, Naperville, IL (US)

Correspondence Address: Richard J. Minnich, Fay, Sharpe, Fagan, Minnich & McKee, LLP, Seventh Floor, 1100 Superior Avenue, Cleveland, OH, 44114, US

(21) Appl. No.: 10/448,635

(22) Filed: May 30, 2003

(51) Int. Cl. H04M 1/00; H04B 1/38

(52) U.S. Cl. 455/435.1; 455/551

(57) ABSTRACT

A system and method of providing communication with a wireless mobile terminal in a wireless communications network having a plurality of wireless communications systems. The method includes sending the mobile terminal's MEC between the wireless communications systems in all intersystem messages that contain the MIN for wireless mobile terminal identifiers. This guarantees the successful termination in the system that uses MECs that can support international roaming. The method also includes collecting wireless mobile terminal MECs and correcting incorrect MECs. The system is a wireless communications network for providing communications for a wireless mobile terminal. The network includes a home system, and a visited system, wherein the home system and visited system communicate with each other using revised intersystem messages which include the use of wireless mobile terminal MECs and the MIN for wireless terminal identification in the place of intersystem messages which use just the MIN

### FIELD OF THE INVENTION

The present invention relates in general to communication systems, and in particular to wireless communication systems that have the need for enabling system evolution from Mobile Identification Number (MIN) to a MIN based International Mobile Station Identity (IMSI) mobile numbers.

### BACKGROUND OF THE INVENTION

In a wireless communications system an identifier is associated with each wireless mobile terminal communicating in the system. The identifier has multiple uses, one use of the identifier is for delivering incoming calls to the wireless mobile terminal, also known as a mobile or a cellular phone. Other uses include, but are not limited to, the registration of the mobile terminal, authentication of the mobile terminal, billing for the mobile terminal, etc. In order to accommodate existing analog and Time Division Multiple Access (TDMA) mobile terminals, Code Division Multiple Access (CDMA) wireless communications systems in the United States can use a fixed 10 digit MIN as the identifier.

Typically, mobile subscribers have roamed within their country borders. As wireless networks have grown and travel has increased, many subscribers want to take their mobile terminals with them increasing the need to support international roaming. International Roaming can be defined as allowing mobile subscribers to receive services at any international location away from their home system while roaming in a visited country.

To enable international roaming, the identifier in the mobile terminal is used to determine the location of the Home Location Register for the mobile terminal. With the ever increasing number of mobile terminals, 10 digits are not enough to uniquely identify a mobile terminal for use in all wireless communications systems worldwide. Since the 10 digit MIN is not globally unique, it does not allow for international roaming. Country codes have been used to identify the country of origin, however this only results in the reuse of the 10 digit MIN throughout the world further complicating the expansion of wireless communications.

Presently, many wireless communications systems are capable of using up to 15 digits for the mobile terminal identifier in an identification plan known as IMSI. Mobile terminals can utilize one or both of two different types of IMSI identifiers as requested by the Mobile Switching Center (MSC).

One IMSI identifier, called MIN-based IMSI, uses a 15 digit identifier consisting of a MIN Escape Code (MEC) as the upper 5 digits and the MIN as the lower 10 digits. For example, every CDMA mobile terminal currently deployed in the United States has an MEC and MIN programmed into it. The other IMSI identifier type is called True-IMSI and it does not contain an MEC and thus is distinct from the MIN-based IMSI identifier. Since not all mobile terminals are capable of using a True-IMSI identifier, existing USA wireless communications systems currently utilize only 10 MIN digits as identifiers. In these systems, mobile terminals can use either the 10 digit MIN identifier or the MIN-based IMSI identifier. The MEC is not sent between systems in these networks.

With CDMA systems, in accordance with CDMA air interface standards IS-95 and IS-2000, a wireless communication system can be configured in only one of two distinct ways. Aside from True-IMSI, one way is for the wireless communication system to require the mobile terminal to send and receive 10 MIN digits as the identifier. The other way is for the mobile terminal to send and receive MIN-based IMSI digits as the identifier. In order to enable mobile terminals to participate in international roaming, it is desirable for wireless systems throughout the world to migrate to using MIN-based IMSI and/or True-IMSI identifiers.

However, a problem exists with using the MIN-based IMSI identifier. Not all mobile terminals are programmed with the correct MEC from the service provider, therefore these mobile terminals cannot be successfully paged using the MIN-based IMSI identifier. Moreover, several different MECs may be assigned within one country. There is no network-wide standard mechanism guaranteeing that the mobile terminal would be paged with an MEC matching the MEC that the mobile terminal has been programmed with. These problems have delayed wireless communications systems' migration to the use of MIN-based IMSI identifiers. It is desirable to provide a way to utilize the MIN-based IMSI identifier despite these existing impediments.

Since not all mobiles deployed support True-IMSI, the migration first to the MIN-based IMSI and then to True-IMSI has been envisioned by the standards bodies. The migration from the MIN-based IMSI to the True-IMSI necessitates that both the MIN-based IMSI and the True-IMSI be sent in the ANSI-41 messages. Since all the mobiles in an MSC area use either MIN or MIN-based IMSI or True-IMSI, but not a combination of these, it is not feasible for all the other home MSCs to start sending True-IMSI to a visited MSC at the same time, after they had been sending the MIN-based IMSI. While True-IMSI may be supported in the ANSI-41 messages by existing systems, MIN-based IMSI is not. MIN-based IMSI was created as the evolutionary step to the True-IMSI after the True-IMSI concept had already existed. Thus, there currently is a need to support both the MIN-based IMSI and the True-IMSI in the ANSI-41 messages.

### SUMMARY OF THE INVENTION

According to the present invention, a system and method of providing communication with a wireless mobile terminal in a wireless communications network having a plurality of wireless communications systems.

In accordance with a first aspect of the invention, the invention is a method including sending the mobile terminal's MEC between the wireless communications systems in all intersystem messages that contain the MIN for wireless mobile terminal identifiers.

In accordance with a second aspect of the invention, the method also includes collecting wireless mobile terminal MECs and correcting incorrect MECs. In accordance with another aspect of the invention, the invention is a wireless communications network for providing communications for a wireless mobile terminal. The network includes a home system, and a visited system, wherein the home system and the visited system communicate with each other using revised intersystem messages which include the use of wireless mobile terminal Mobile identity number Escape Codes (MECs) and the MIN for wireless terminal identification in the place of intersystem messages which use just the MIN.

### DETAILED DESCRIPTION OF THE INVENTION

Referring now to FIG. 1 a portion of a wireless communications network is shown generally at 10. The network 10 includes a home system 12a having one or more base stations, one of which is shown at 16a, for communicating with wireless mobile terminals 18 over an air interface 20. The home system 12a also includes a home mobile switching center (MSC) for communicating with and/or controlling one or more of the base stations 16a or a home Stand Alone Home Location Register (SHLR) 14a.

The wireless mobile terminal 18 can be any suitable mobile terminal, also known as a mobile or a cellular phone, for communicating in a wireless network. The mobile terminal 18 can provide voice communications, and can be capable of sending and receiving data as well.

The network 10 also includes other systems, one of which is shown at 12b, similar to the home system 12a and disposed at other locations. The other system 12b includes one or more base stations 16b and one or more MSCs 14b similar to those in the home system 12a. The wireless communications systems 12a, 12b communicate with each other at 19 thereby enabling the mobile terminal 18 to move about, communicating with the network 10 by using other systems 12b besides the home system 12a. In those cases, the other system 12b is referred to as a visited system. If the mobile's information is stored in SHLR, then the mobile could be viewed as always being in a visited system, that is always roaming, since it does not have a home MSC. The SHLR does not directly communicate with base station(s).

The invention includes a method for providing communication with a wireless mobile terminal 18 in a wireless communications network 12 whereby the mobile terminal's MEC is sent as part of the messages, shown generally at 22, which are sent between MSCs and/or SHLRs 12. The communications network 10 can be a CDMA network or any other suitable wireless communications network. When autonomous registration is on, as it is for systems in the USA, the MEC will be available in the home system shortly after the mobile is powered on. This in turn means that the correct MEC will be used for the paging and thus the termination will be successful.

As is generally well known, ANSI41 messages sent between wireless communications systems 12, include the MIN and/or one True-IMSI identifiers. As described above, using only the 10 digit MIN as the identifier poses problems for international roaming since the MIN may not be globally unique. In accordance with the invention, the wireless mobile terminal identifiers sent between the wireless communication systems 12 in the ANSI41-type messages include the MEC and the MIN. In order to accomplish the invention, it is anticipated that the ANSI41 standard be amended to allow the messages using the MEC, as well as the MIN, as the wireless mobile terminal identifier. Accordingly, the term “ANSI41-type” refers to messages which are similar to current ANSI41 messages except for the changes needed to include the use of the MEC as described herein. However, it should be appreciated that ANSI41 and ANSI41-type messages are used herein as examples, which should not be considered as limiting, and that the invention is applicable to any revised intersystem messages capable of using the MEC, as well as the MIN, as the wireless mobile terminal identifier in place of current intersystem messages sending only the MIN as the mobile terminal identifier. Accordingly, the invention is applicable to suitable intersystem messages in networks including but not limited to GSM networks, TDMA networks, CDMA networks and any known proprietary networks.

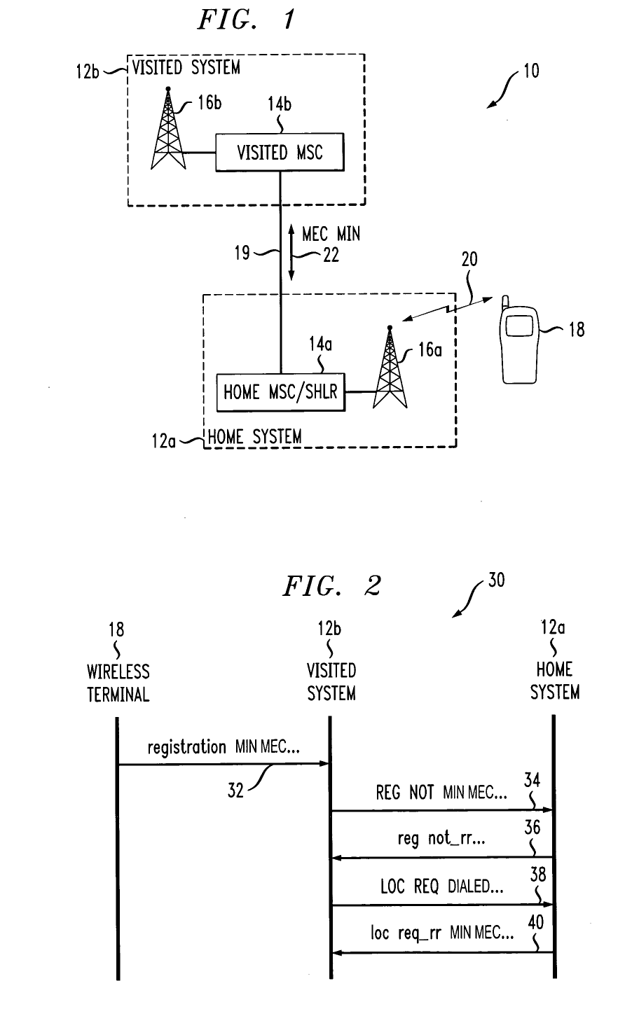

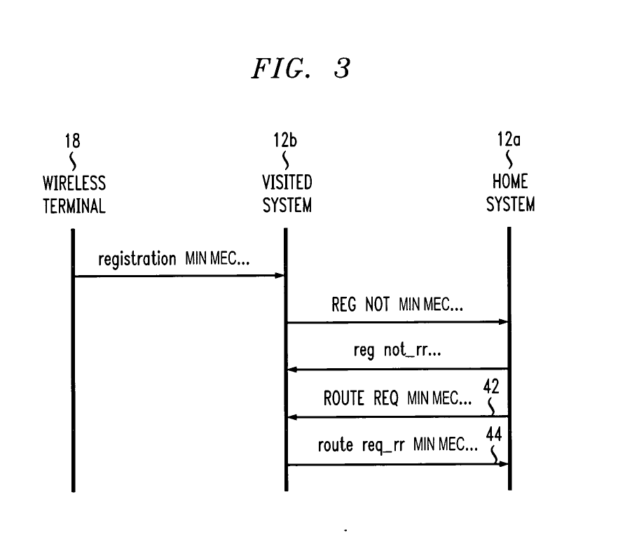

Referring now to FIG. 2, an example of the invention is shown in the message flow shown generally at 30. For the purposes of this example, it should be assumed that the network 10 operates in the mode that supports MIN-based IMSI wireless mobile terminals. The wireless mobile terminal 18 registers in the visited system 12b, sending the MEC programmed into the mobile terminal and the wireless mobile terminal's MIN as identifiers of the wireless mobile terminal to the visited system at 32. This identifier can be stored temporarily in the Visitor Location Register (not shown).

The visited system 12b then sends a RegistrationNotification INVOKE ANSI41-type message to the home system 12a, either an MSC or SHLR, at 34. This message would contain the MEC that the wireless mobile terminal 18 sent to the visited MSC 12b during the registration at 32. The home system 12a processes and may store, in any suitable manner such as in a database, this MEC. A RegistrationNotification RETURN RESULT message is then sent from the home system 12a to the visited system 12b at 36. At 36, the MEC may be included as part of the RegistrationNotification RETURN RESULT.

When the termination to the wireless mobile terminal 18 occurs, the visited system 12b may have all the information needed for paging the wireless mobile terminal 18 obtained from the home system 12a, since typically, the MEC was stored in the visited system's VLR. An incall (not shown) has been received at the Visited MSC 12b for the wireless mobile terminal 18. A LocationRequest INVOKE message is sent to the home system 12a from the visited system 12b at 38. The home system 12a replies with LocationRequest RETURN RESULT at 40 which tells the visited system 12b that the visited system has the wireless mobile terminal 18 and also sends the wireless mobile terminal's MEC. The MEC is sent in the LocationRequest RETURN RESULT at 40 because the VLR may have been removed or expired prior to the incoming call for the wireless mobile terminal 18.

Thus, this MEC in the LocationRequest RETURN RESULT 40 guarantees the successful termination with the reasonable assumption that the visited system had sent the MEC in the RegistrationNotification INVOKE 34.

Further, in accordance with the present invention, since the MEC is used in these ANSI41-type messages and sent back to the home system, the home system can collect the MEC and compare the MEC with the stored value of the MEC, if available. It is known that some wireless mobile terminals 18 contain incorrect MECs. Since the known ANSI41 system only uses MINs as identifiers, incorrect MECs have not been detected. Therefore, the information that is stored in the mobile is used to verify and audit the data that may have been stored in the HLR. This should occur once and all later accesses by the mobile subscriber could verify that the mobile is valid through the comparison of the previously known MEC and the current value sent by the mobile on its last access.

By sending the MEC between wireless communication systems 12, this invention enables incorrect MECs to be found and corrected. This can be done in the home system 12a or the Visited system 12b if a VLR still exists or there may be another mechanism for capturing the roamer information. An incorrect MEC can be corrected manually or it can be corrected over the air if the wireless communication systems 12 and the wireless mobile terminal 18 have the capability to provide updates to the MEC over the air.

The invention enables successful termination to a visiting wireless mobile terminal 18 using the MEC as well as the MIN in ANSI41-type messages sent in an ANSI41 network. Hence, the invention enables the wireless provider to deploy international roaming by using 15 digits for wireless mobile terminal station's identity. Thus, the wireless mobile terminal user, the subscriber, would be able to use their wireless mobile terminal anywhere in the world.

By the eventual use of MIN-based IMSI, 15 digit identifiers, the ability to detect fraudulent use is improved because of the greater granularity of the numbers.

The invention provides several advantages. Subscribers will be able to continue to use existing wireless mobile terminals even after the service providers change the network mode to allow international roaming using IMSI. Also, international roaming would be available using IMSI as in standards. This would be superior to any other intermediate attempts to extend the national way of roaming internationally. Also, service providers would be able to cover several distinct MECs within a country as standards and/or government agencies dictate. These service providers would not have to reprogram wireless mobile terminals with incorrectly programmed MECs in them. Incorrectly programmed MECs in the wireless mobile terminals is a huge issue which has so far prevented IMSI feature from broad deployment. This is especially true in the USA where many wireless mobile terminals currently working fine with MIN have incorrect MECs which will become visible only when IMSI is deployed.

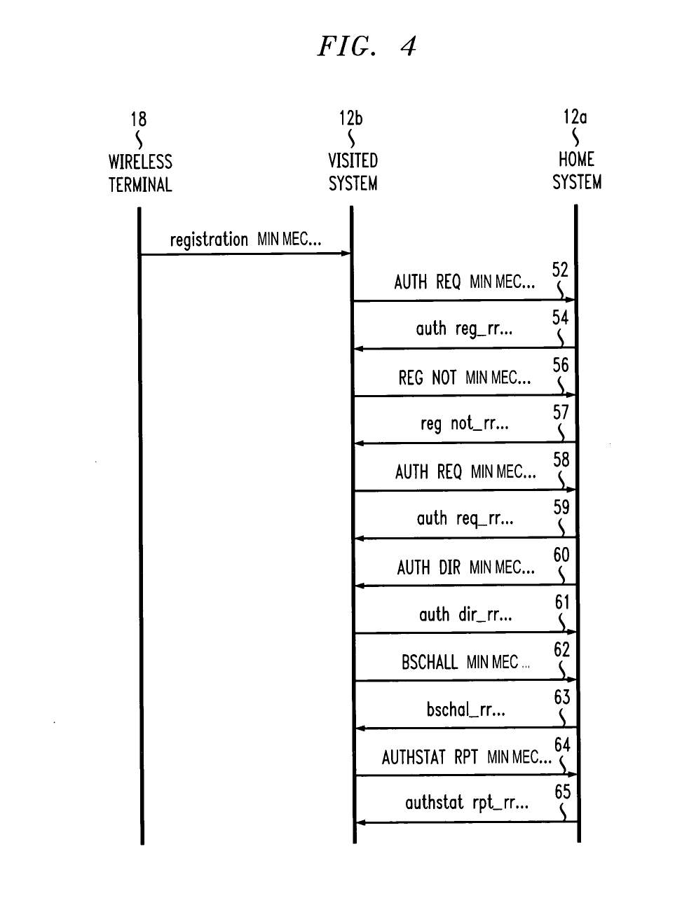

The rest of the examples which is in FIGS. 3, 4, and 5 are analogous to the example in FIG. 2, where the pre-existing MIN parameter in current ANSI41 messages is replaced with the MEC and MIN in the revised ANSI41-type messages.

FIG. 3 also shows registration followed by termination, this time the incall (not shown) comes to the home system 12a. The home MSC 14a knows from the registration where the mobile 18 is. When the incall comes, the home MSC 14a then sends the RouteRequest INVOKE 42 to the visited MSC 14b. This message asks the visited MSC 14b for the necessary information to route the call. MIN and MEC are included in RouteRequest INVOKE 42 since the MEC was either known prior to the registration or was obtained during the registration. The visited MSC 14b sends the necessary information to route the call in the RouteRequest RETURN RESULT 44.

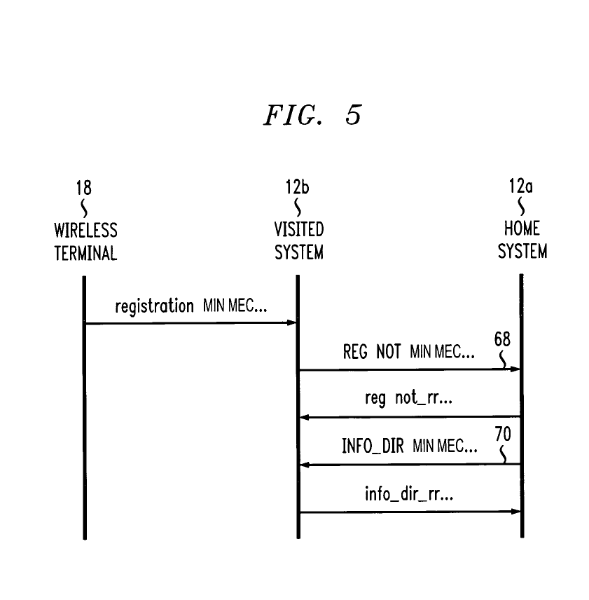

A possible sequence where a roaming mobile originates a call and then the auto Shared Secret Data (SSD) update happens is shown in FIG. 4. After the SSD update in the mobile 18, the SSD is used for the mobile authentication for each subsequent phone call, where the SSD in the mobile has to match the respective SSD stored in the authentication center which is typically in home MSC 14a. Following the registration message, such as an autonomous registration message, from the mobile 18 sent during power up, the AuthenticationRequest INVOKE message 52 conveys the MEC to the home system 12a. The home MSC 14a replies with AuthenticationRequest RETURN RESULT 54. Then, the sequence of the following INVOKE messages (and corresponding RETURN RESULT messages) follows, as shown in FIG. 4: RegistrationNotification 56, 57, AuthenticationRequest 58, 59, AuthenticationDirective 60, 61, BaseStationChallenge 62, 63 and AuthenticationStatusReport 64, 65.

The situation where the terminating calls are unconditionally call forwarded from the mobile and where the mobile user hears the abbreviated alert whenever the mobile is called (while the call is forwarded elsewhere) is illustrated in FIG. 5. There, the InformationDirective INVOKE 70 message causes eventually the mobile to sound the abbreviated alert (after the appropriate messages are sent from the MSC to the base station and from the base station to the mobile). The MEC is conveyed from the MSC in this InformationDirective INVOKE 70, since it is known from the RegistrationNotification INVOKE 68, or from prior to that.

The invention has been described with reference to preferred embodiments. Obviously, modifications and alterations will occur to others upon reading and understanding the preceding specification. It is intended that the invention be construed as including all such modifications and alterations insofar as they come within the scope of the appended claims or the equivalents thereof.

We claim:

1. A method for providing communication with a wireless mobile terminal in a wireless communications network having a plurality of wireless communications systems, the method comprising:
sending the mobile terminal's Mobile Identification Number (MIN) Escape Code (MEC) between the wireless communications systems in all intersystem messages that contain the MIN for wireless mobile terminal identifiers.

2. The method defined in claim 1 wherein autonomous registration is on.

3. The method defined in claim 1 further including paging the wireless mobile terminal in the visited system using the MEC and MIN.

4. The method defined in claim 1 further comprising:
collecting wireless mobile terminal MECs; and
correcting incorrect MECs.

5. The method defined in claim 4 wherein the collecting step includes collecting a wireless mobile terminal's MEC in the home system when the wireless mobile terminal is at home or roaming.

6. The method defined in claim 4 further including storing the wireless mobile terminal MEC in the home system.

7. The method defined in claim 4 wherein the correcting step includes manually correcting the incorrect MECs.

8. The method defined in claim 4 wherein the correcting step includes correcting incorrect MECs over the air.

9. The method defined in claim 1 wherein the intersystem messages are ANSI41-type messages.

10. The method defined in claim 1 wherein the wireless communications network is a GSM network.

11. The method defined in claim 1 wherein the wireless communications network is a TDMA network.

12. The method defined in claim 1 wherein the wireless communications network is a CDMA network.

13. A wireless communications network for providing communications for a wireless mobile terminal comprising:
a home system; and
a visited system, wherein the home system and visited system communicate with each other using revised intersystem messages which include the use of wireless mobile terminal Mobile identity number Escape Codes (MECs) and the MIN for wireless terminal identification in the place of intersystem messages which use just the MIN.

14. The wireless communications network defined in claim 13 wherein the home system is a Mobile Switching Center.

15. The wireless communications network defined in claim 13 wherein the home system is a Stand alone Home Location Register.

16. The wireless communications network defined in claim 13 wherein the revised intersystem messages are ANSI41-type messages and the intersystem messages are ANSI41 messages.

17. The wireless communications network defined in claim 13 wherein the wireless communications network is a CDMA network.

18. The wireless communications network defined in claim 13 wherein the wireless communications network is a TDMA network.

19. The wireless communications network defined in claim 13 wherein the wireless communications network is a GSM network.

20. The wireless communications network defined in claim 13 wherein the wireless communications network is a proprietary network.
